(19) United States
(12) Patent Application Publication
(10) Pub. No.: US 2015/0172426 A1
(43) Pub. Date: Jun. 18, 2015

(54) ANTENNA TUNING CORRECTION FOR MULTIPLE REAR HOUSING MATERIALS

(71) Applicant: MOTOROLA MOBILITY LLC, Libertyville, IL (US)

(72) Inventors: Vijay L. Asrani, Round Lake, IL (US); Paul L. Fordham, Wauconda, IL (US); Khan Mohammed Z Shams, Lindenhurst, IL (US)

(73) Assignee: MOTOROLA MOBILITY LLC, Libertyville, IL (US)

(21) Appl. No.: 14/107,182

(22) Filed: Dec. 16, 2013

(51) Int. Cl. H04M 1/02; H04B 1/40

(52) U.S. Cl. CPC H04M 1/0249; H04B 1/40

(57) ABSTRACT

A UE is provided having a front housing and a rear housing. The rear housing is made of a material that affects the operation of an antenna when operating at different frequency bands. The rear housing includes an actuator configuration that is sensed by an actuator sensor within the housing when the housing is assembled. The actuator configuration indicates the material used to construct the rear housing. Upon sensing the actuator configuration, the UE is configured to tune the antenna for efficient operation at the operating frequency band while proximate to the rear housing.

### TECHNICAL FIELD

The present invention generally relates to mobile communications and, more particularly, to optimizing antenna performance of an antenna within a mobile communication device based on the mobile communication device's diverse housing material.

### BACKGROUND

It has become common for mobile communication devices to be provided with a choice of different mobile device housing configurations, wherein each different configuration has a housing made of different materials for the same or similar mobile communication device models. Each mobile communication device's housing material may have different electrical parameters associated therewith. Such differing electrical parameters affect the optimal antenna performance of one or more of the communication antennas within the mobile communication device's housing. For example, ceramic, composite, metal or plastic housings all have different electrical parameters that ultimately affect antenna performance. The antenna performance is affected by the different housing materials detuning the antenna out of the frequency band of interest. In particular, if a mobile communication device's antenna is tuned to operate with a plastic housing or cover while operating in the 850 MHz transmit or receive band, replacement of the plastic cover with a ceramic housing with no additional correction applied to an antenna matching circuit will detune the antenna response to a lower frequency band of about 770 MHz due to the higher dielectric constant of the ceramic housing. The final result will be degradation of the mobile communication device's antenna efficiency.

### BRIEF DESCRIPTION OF THE DRAWINGS

For a more complete understanding, reference is now made to the following description taken in conjunction with the accompanying Drawings in which:

FIG. 1 depicts a simplified block diagram of an interior of an open mobile communication device featuring the inside of the front housing portion and the inside of the rear housing portion;

FIGS. 2A and 2B depict exemplary actuator sensor and actuator configuration combinations in accordance with various embodiments;

FIG. 3 is a basic logic schematic of an actuator configuration and actuator sensor combination;

FIG. 4 is a block diagram of exemplary circuitry within a mobile communication device;

FIG. 5 is a block diagram schematic of an exemplary embodiment and exemplary state data base for various housing materials;

FIG. 6 is a block diagram of an exemplary actuator detection database configuration;

FIG. 7 is a flowchart of an exemplary antenna tuning correction process; and

FIG. 8 is a diagram of an alternate exemplary actuator combination.

### DETAILED DESCRIPTION

While the specification concludes with claims defining features of the invention that are regarded as novel, it is believed that the invention will be better understood from a consideration of the description in conjunction with the drawings. As required, detailed embodiments are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ embodiments in virtually any appropriately detailed structure. Further the terms and phrases used herein are not to the intended to be limiting but rather to provide an understandable description of the invention.

What is needed is a system and method for a mobile communication device that determines the type of housing material installed on the mobile communication device so that the circuitry of the mobile communication device can retune the antennas according to the housing material and thereby maintain antenna transmit and receive efficiency.

A mobile communication device is provided that has a housing with a front housing portion and a rear housing portion. The rear housing portion is made of a material that affects the efficient operation of a mobile communication device antenna when transmitting or receiving different frequencies. The rear housing portion includes an actuator configuration adapted to be sensed by an actuator sensor within the mobile communication device when the rear and front housing portions are assembled. The actuator configuration provides an indication of the particular material of which the rear housing portion is constructed. Upon sensing the actuator configuration the mobile communication device is configured to tune the antenna to operate efficiently at the frequency band of operation when proximate to the rear housing portion.

A wireless communication device for use with the wireless communication system in accordance with this disclosure may be a portable, handheld or mobile telephone or smart phone, a Personal Digital Assistant (PDA), a portable computer, portable television and/or similar mobile device or other similar communication device. In the following description, the communication device will be referred to generally as a UE (User Equipment) for illustrative purposes and as such is not intended to limit the disclosure to any particular type of wireless communication device.

Exemplary embodiments provide a system and method that enables the UE to determine the housing material of the UE so as to adjust or tune the transmit or receive antennas to operate more efficiently in each transmit or receive band used by the UE transceiver.

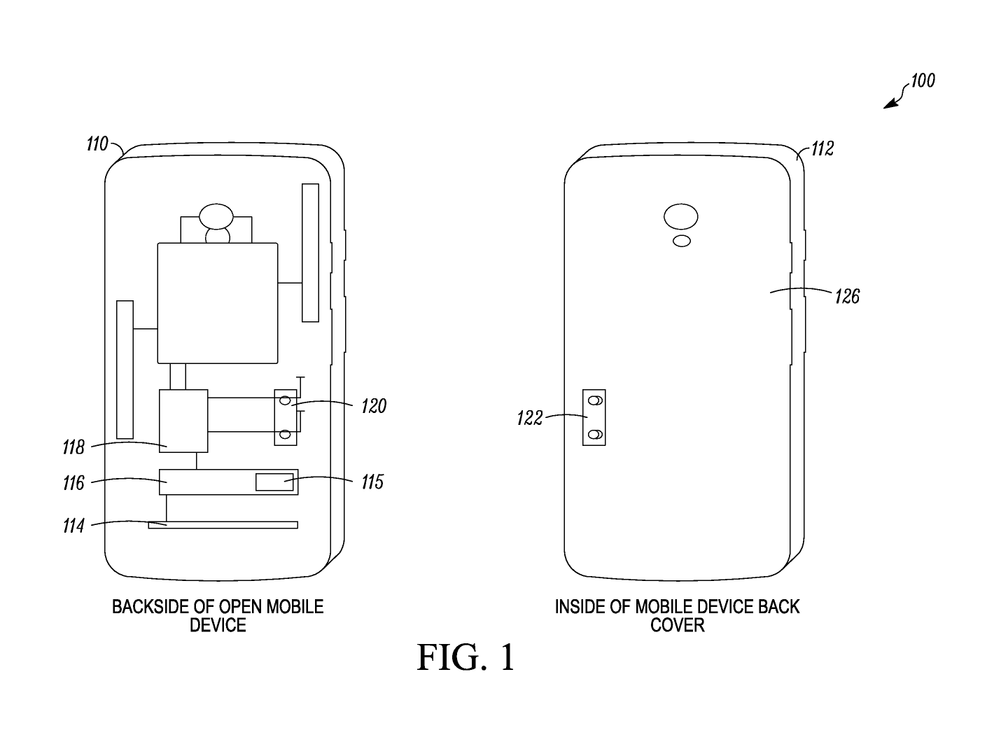

FIG. 1 depicts an exemplary UE 100 that is opened (as opposed to assembled) to show a basic block diagram of the circuitry inside of the front housing 110 (looking from the back) as well as the inside of the rear housing 112. An antenna 114 is positioned proximate to a lower edge of the front housing 110. The antenna 114 may transmit or receive communication signals. The antenna 114 is connected to antenna tuner circuit 115 and transceiver circuit 116. The antenna tuner circuit is usually between the transceiver 116 and the antenna 114. The antenna tuning circuit 115 is used to match the impedance between the transceiver circuit 116 and the antenna 114 in order to maximize the signal transmission and reception efficiency. The transceiver 116 transmits and receives data, voice and other communication signals at various frequency bands and in various formats depending on the communication network that the UE is operating within.

The processor 118 is connected to the transceiver circuit to provide a wide variety of control signals, data and other electrical connections. In this embodiment the processor 118 provides, among other things, a tuning signal or tuning offset signal that is ultimately used by the antenna tuner circuit for tuning the antenna for the transmit or receive frequency band based on the particular material or material composition of the rear housing portion 112. The processor 118 is connected to an actuator sensor 120. Actuator sensor 120 is configured such that when the rear housing portion 112 is connected to the front housing 110, thereby completing the housing assembly of the UE 100, the actuator configuration 122 is sensed by the actuator sensor 120. The actuator sensor 120 thereby provides an actuator sensor signal 124 that can be read by the processor 118. The processor 118 utilizes the actuator sensor signal 124 to recognize the type of material used to make the rear housing portion 112. In this embodiment the actuator configuration 122 is a physical structure or feature positioned on the inside of the rear housing 126 and aligned to interact with or be sensed by the actuator sensor 120, which is positioned on the inside of the front housing 110. In some embodiments the actuator sensor 120 may be configured or positioned on a surface of a printed circuit board (PCB) mounted on the inside of the front housing 110.

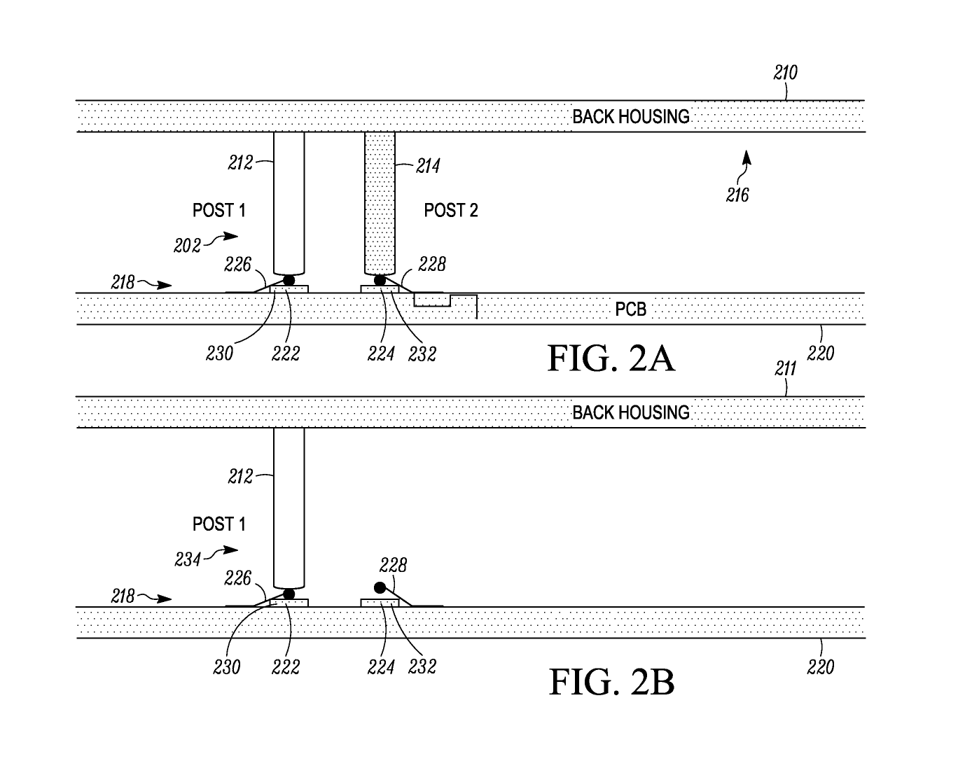

Referring now to FIG. 2A, and exemplary implementation of an embodiment is shown. In particular, a rear housing portion 210 has an actuator configuration 202 comprising two posts, a first post 212 and a second post 214. Each post or feature 212, 214 extends from the inside surface 216 of the rear housing portion 210 such and configured to align with and/or interact with the actuator sensor 218, which is positioned on a PCB 220 inside the front housing of the UE (not specifically shown). The actuator sensor 218 comprises a first switch 222 and a second switch 224. When the front housing portion and rear housing portion are assembled the first post 212 and the second post 214 compress, in this embodiment, a first leaf spring 226 and second leaf spring 228, respectively, making contact with a first pad 230 and second pad 232 of the first and second switches 222, 224. In FIG. 2B, if one of the posts is missing the respective switch contact pad is left open indicating a different housing. The processor, being connected to the actuator sensor 218, uses the output actuator sensor signal information to decode the type of material or material composition of the rear housing portion 211. In this embodiment if there are “N” number of posts on the rear housing portion making up an exemplary actuator configuration, then there are 2^{N} combinations of posts that can be used to differentiate 2^{N} different housing rear cover materials. Thus, if a maximum of two posts are used, then four (2×2) different materials can be differentiated. If three posts are used, then eight materials (2×2×2) can be differentiated. In FIG. 2A the actuator configuration 202 provides both the first post 212 and the second post 214, which will be read or received as an actuator sensor signal by the processor as a binary 1 1 since both posts are closing the first switch 222 and second switch 224 circuits. In FIG. 2B there is a different actuator configuration 234, which is read or received by the processor as a binary 1 0. After reading or receiving the actuator sensor signal, the processor looks up, in a data base or look up table, the particular material of the rear housing portion 210, 211 designated by the actuator configuration 202 or 234. Based on the particular material of the rear housing portion, the processor provides a tuning signal to a tuning circuit so as to correctly impedance match the transceiver with the antenna for the particular rear housing material and the frequency band being used by the transceiver.

It is understood that in some embodiments the rear housing portion 210 may not entirely cover the backside of the UE. More particularly, in some embodiments the rear housing portion 210 may partially cover the backside of the UE and/or be positioned to cover an area of the housing proximate to the antenna that the transceiver transmits or receives radiofrequency signals on.

Additionally, in some embodiments a user of the UE may or may not be able to remove the rear housing portion 210 and exchange it with another rear housing portion made of a different material. In some embodiments the UE determines the rear cover portion material composition when the phone is first turned on. While in alternate embodiments the UE checks every time it is power cycled and/or periodically to determine whether a present rear housing portion has been exchanged for another rear housing portion that is made of a different material.

Additionally, in various embodiments the actuator configuration may be comprised of a variety of physical shapes or materials that are used to actuate the switch or switches that make up the actuator sensor. For example, the actuator configuration/actuator sensor combination may comprise one or more magnets/and magnetic switches, carbon pills/and resistive switches, capacitance sources/and capacitive sensors, posts/and optical readers, raised portions and switch pads or reflowed mechanical switches, etc. Additionally, the actuator sensor may be located on a PCB, micro circuit or other reasonable facsimile thereof as shown in FIG. 2A, 2B or on an inside surface of the UE front cover or housing portion.

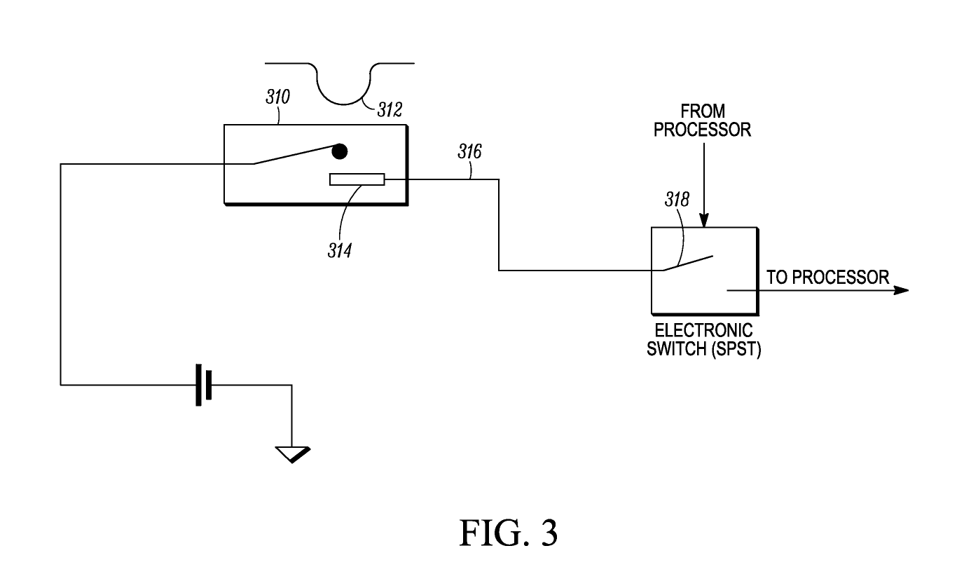

FIG. 3 depicts a basic logic schematic of an actuator configuration/actuator sensor pair. When the actuator sensor 310 senses the actuator configuration 312, the actuator sensor 310 may close an actuator sensor switch 314. When the processor (not specifically shown) is to read the switch position or actuator sensor signal, the processor sends a read signal to an electronic switch 318 which completes a circuit between the actuator sensor 310 and the processor. When electronic switch 318 is closed energy or power is used. To limit the amount of power being used by the actuator sensor the processor sends a don't read signal to the electronic switch 318 to open the electronic switch 318 so that energy is conserved when the processor is not reading the actuator sensor 310. Generally, once the processor determines the type of material that the rear cover portion is made of (i.e., receives the actuator sensor signal from the actuator sensor) there is no reason to continue sensing the status of the actuator sensor 310 thus the electronic switch 318 is turned off in order to save current drain. In some embodiments, the processor reads the actuator sensor signal 316 provided by the actuator sensor 310 each time the mobile device is turned on. In some circumstances, wherein the rear cover portion of the UE can be removed without cycling the UE power, the processor is set to close the electronic switch 318 and read the actuator sensor signal 316 provided by the actuator sensor 310 at predetermined periodic times so as to determine whether a user has changed or recently changed the rear cover portion of the UE.

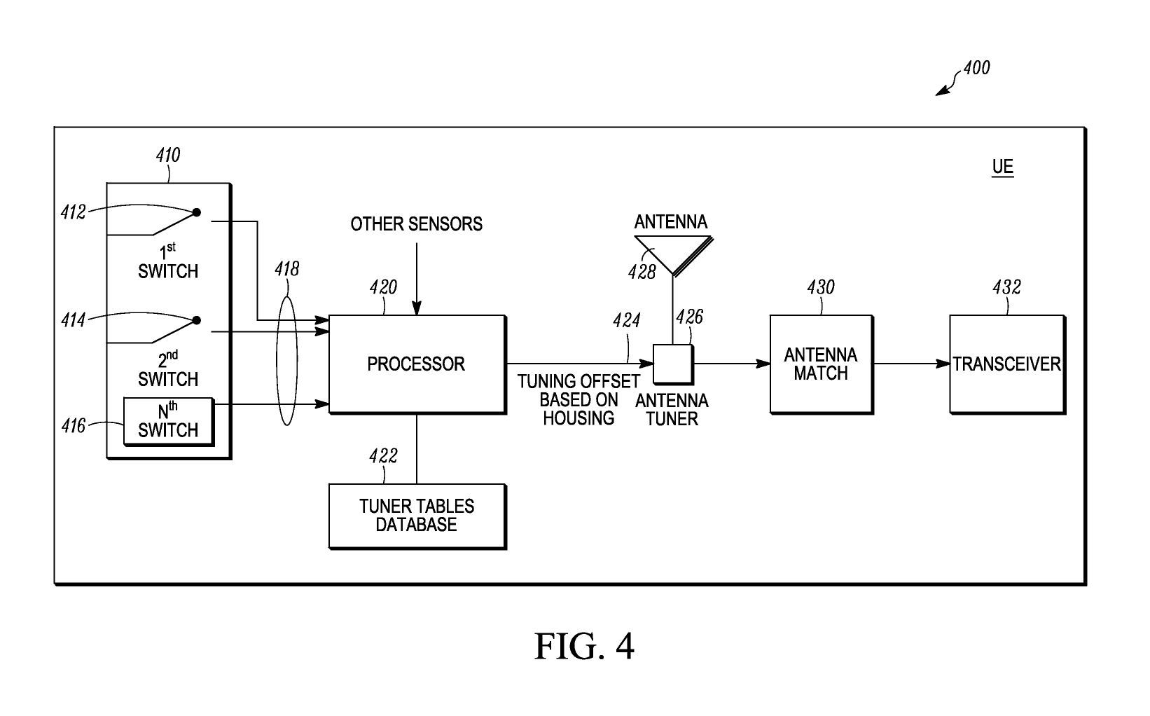

FIG. 4 depicts an exemplary UE 400. The exemplary UE 400 has an actuator sensor 410 comprising a plurality of mechanical or electronic switches, being a 1st switch 412, a 2nd switch through an Nth switch 416. Each switch is configured to sense the configuration of the actuator configuration and to produce an actuator sensor signal 418. The actuator sensor signal 418 is received or read by the processor 420. The processor 420 uses the actuator sensor signal 418 to detect the type of material from which the rear cover portion is composed. In some embodiments, the processor 420 uses the actuator sensor signal 418 to lookup in a tuner table 422 a predetermined offset signal or tuning signal 424 to provide to the antenna tuner circuit 426. The antenna tuner 426 uses the tuning offset signal 424 to adjust its impedance so as to combine with the antenna matching circuit 430 and tune the antenna 428 to have a better impedance match with the input or output of the transceiver when the transceiver 432 is receiving or transmitting a signal, respectively, of a particular frequency band. Thus based on the actuator configuration, the actuator sensor 410 provides an actuator sensor signal 418 to the processor 420. The processor 420, based on the actuator sensor signal 418, provides an appropriate offset signal or tuning offset signal 424 to the antenna tuner 426 so that the antenna 428 is properly tuned (i.e., impedance matched) for the particular housing material that is proximate to the antenna and for the particular frequency band being transmitted or received by the transceiver 432.

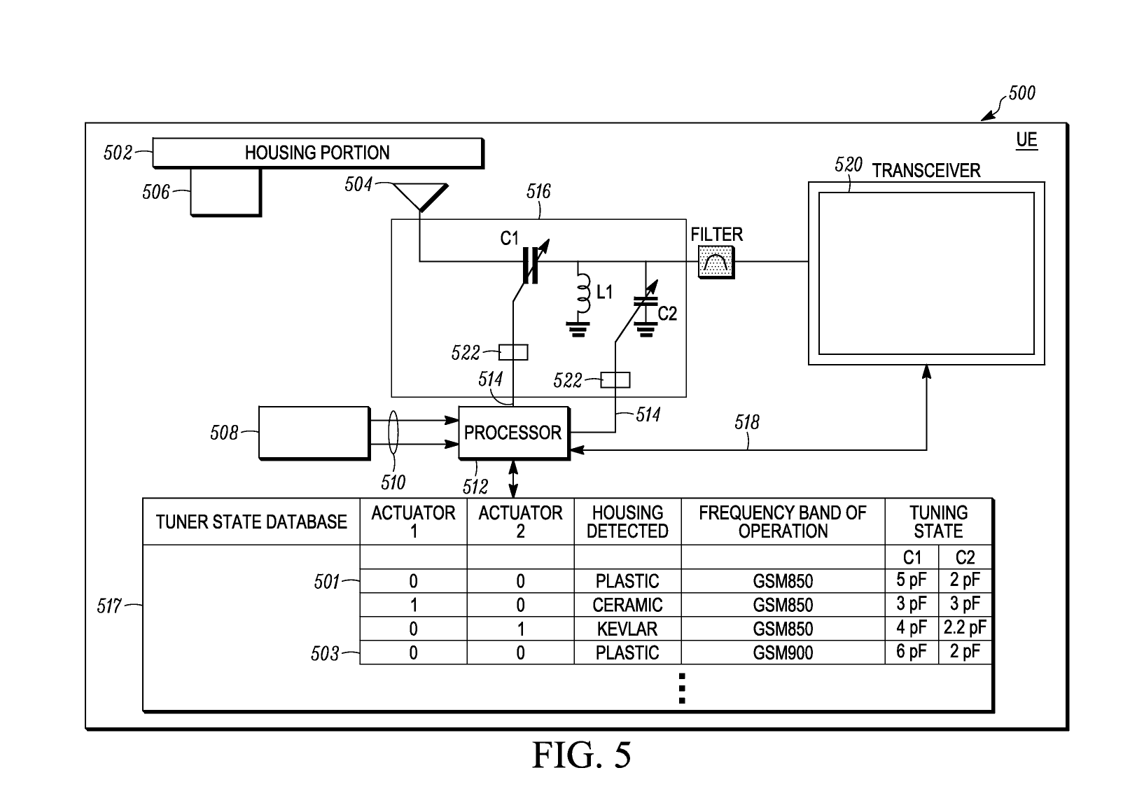

FIG. 5 is a schematic of an exemplary UE configured to make antenna tuning corrections for multiple UE housing materials. The UE 500 comprises a housing material 502 that covers or partially covers and antenna 504. Since different types of housing materials have different electrical parameters, the housing material 502 has an actuator configuration 506 that designates the particular housing material 502 by means of a physical orientation, capacitive orientation, magnetic orientation, resistive orientation, optical orientation, RFID, or other orientation indicia that can be sensed or read by an actuator sensor 508. The actuator sensor 508 is configured to sense or read the actuator configuration 506 when the housing material 502 is covering or partially covering the antenna 504. In some embodiments the actuator configuration 506 can only be read by the actuator sensor 508 when the UE housing is assembled.

Upon sensing the actuator configuration 506, the actuator sensor 508 provides an actuator sensor signal 510 to the processor 512. The processor 512 reads the actuator sensor signal 510 and uses it to determine an appropriate tuning signal(s) to provide to an antenna tuner circuit 516. In some embodiments the processor 512 uses the actuator sensor signal 510 to lookup in a tuner state database 517 the housing material type. As shown in FIG. 5, if the exemplary actuator sensor signal 510 is a binary 0 0, then the housing material detected is plastic. If the actuator sensor signal 510 is a binary 1 0, then the housing material detected is ceramic. If the actuator sensor signal 510 is binary 0 1, then the material detected is Kevlar. Additionally in some embodiments, the processor receives a band signal 518 from the transceiver, which indicates the frequency band the transceiver 520 is transmitting or receiving over the antenna 504. In other embodiments it is the processor 512 that is communicating the frequency band to be used to the transceiver, thus the processor already knows what frequency band is to be transmitted or received by the transceiver 520. The processor 512 uses the combination of the detected housing and the frequency band that the transceiver 520 is operating in to determine or look up in the tuner state database 517, the tuning signal that represents the necessary tuning state of capacitors C1 and C2 of the antenna tuning circuit 516 required to match the impedance between the antenna 504 and transceiver 520 for the particular frequency band and housing material.

The tuning signal 514 is provided from the processor 512 to the antenna tuning circuit 516 and received by one or more digital to analog (D/A) converters 522, which convert the tuning signal 514 into appropriate voltages that adjust the impedance of the variable capacitors C1 and C2. The adjustment of the variable capacitors C1 and C2 set the impedance of the antenna tuner circuit 516 so that the antenna 504 is tuned (i.e., impedance matched) with the transceiver 520 for the particular frequency band and the particular housing material 502. Each time the frequency band of the transceiver 520 changes, the processor 512 will provide the appropriate tuning signal 514 to the tuning circuit 516 so that the antenna is properly tuned for both the changed frequency band being used by the UE and the particular housing material on the UE.

The tuning signal 514 provided by the processor is usually a digital signal, which in some embodiments is received by the antenna tuning circuit 516 and decoded to determine voltages to be provided to one or more variable capacitors, such as capacitors C1 and C2. In other embodiments the digital signal provided by the processor 512 is received by a D/A converter 522 within or outside of the antenna tuner circuit 516. The D/A converter 522 converts the digital tuning signal 514 to appropriate voltage values which are received by the capacitive tuners C1 and C2. The capacitive tuners C1 and C2 may be barium strontium titanate (BST) tunable capacitors, micro-electro-mechanical systems (MEMS) tunable capacitors, field effect transistor (FET) tunable capacitors, or other known or created tunable impedance circuits.

Additionally as shown in the tuner state database 517 of FIG. 5, the top row 501 and the bottom row 503 both indicate that the actuator sensor signal 510 is binary 0 0, thus in both rows the housing is determined to be composed of a plastic material. The difference between the two rows 501, 503 is that the frequency band that the transceiver is operating in is different, thus the tuning state of the capacitors C1 and C2 will be different, and the tuning signal 514 provided from the processor to the antenna tuner circuit 516 will also be different. Thus, both the sensed actuator configuration and the frequency of transceiver operation affect the C1 and C2 values (i.e., the tunable impedance of the antenna tuner circuit 516) in order to maintain enhanced antenna performance based on the detected housing material in conjunction with the frequency of operation.

Described another way, FIG. 5 depicts an exemplary mobile communication device 500 having a particular housing material 502. On a portion of the housing material that is inside the housing there is an actuator configuration 506 that is configured to indicate the particular housing material. Additionally, inside the housing, is an actuator sensor 508 that is adapted to sense the configuration of the actuator configuration 506 when the housing of the mobile communication device 500 is assembled. A processor 512 is connected to the actuator sensor 508 and configured to read an actuator sensor signal 510, which is provided by the actuator sensor 508. The actuator sensor signal 510 provides an indication of the actuator configuration and thus indicates the particular housing material 502 comprising the housing portion. Additionally, within the mobile communication device is an antenna 504, a transceiver 520 and an antenna tuner circuit 516. The antenna tuner circuit is connected between the transceiver 520 and the antenna 504. The antenna tuner circuit 516 is configured to receive the indication of the actuator configuration or tuning signal 514 from the processor 512 and use it to set and impedance of the antenna tuner circuit 516.

In some embodiments, the impedance of the antenna tuning circuit 516 is set by adjusting one or more tunable capacitors, for example C1 and/or C2. The impedance is set such that the antenna 504 operating proximate to the housing material 502 will closely match the impedance of the transceiver 520 operating at a selected or particular frequency band. In various embodiments the tuner state database 517 is stored within a memory device, which can be read by the processor 512. The processor uses the actuator sensor signal 510 and the operating frequency of the transceiver 522 select an appropriate tuning state (i.e., tuning signal 514) from the data base 517 to provide to the antenna tuner circuit 516. Each time the transceiver 520 changes its operating frequency band, the processor 512 accesses and reads the tuner state database 512 to retrieve the appropriate tuning signal 514 to provide to the antenna tuner circuit 516 for the particular housing material and frequency band.

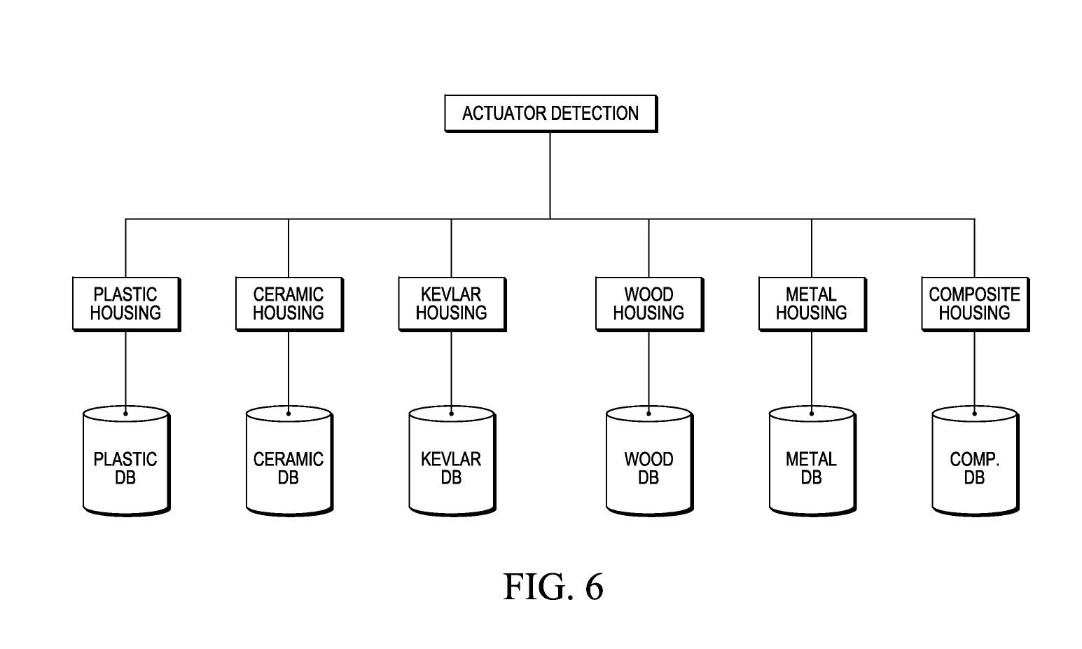

FIG. 6 provides a visual representation of the various databases stored in the memory of the UE as the tuner state database. Here the actuator sensor can detect a plurality of different housing materials. The detection may indicate that the housing material or backside housing material of the UE is made of a plastic material (including, but not limited to a specific type of polymer, epoxy resin, plastic resin, glass filled or talc filled resin, PVC, etc.), a ceramic material, a Kevlar-based material, a wooden material, a metal or metal alloy material, or a composite material. A composite material may be material that includes a variety of materials whether mixed, layered or collaged. Additionally a composite material may be, for example, an epoxy resin or plastic material having a particular coloring or additive added thereto that changes the electrical parameters of the material and thereby affecting the tuning of an antenna within the UE that is proximate thereto. FIG. 6 shows that if, for example it is determined that a ceramic material is sensed by the actuator sensor, the processor will go to the ceramic housing database to find the appropriate tuning signal based on the ceramic housing and the frequency band that the UE is presently using. Thus for each frequency band, GSM, 3G, 4G, CDMA, LTE, etc., the processor can find an appropriate tuning signal 514 for the sensed housing material 502.

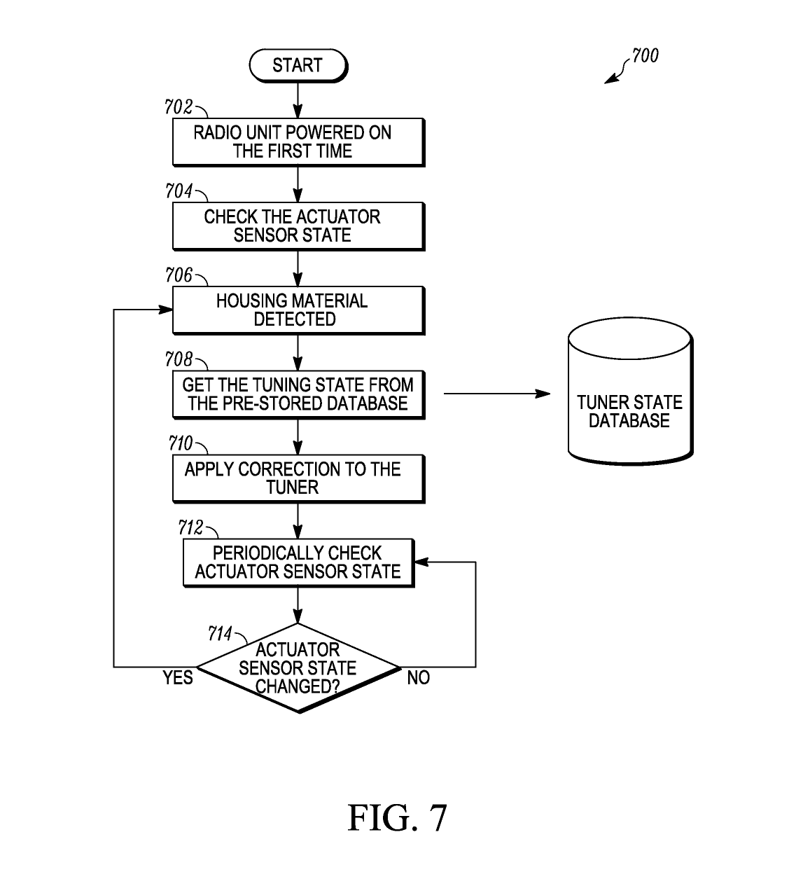

Referring now to FIG. 7, a flowchart is provided that depicts an exemplary method of correcting the antenna tuning of a UE for multiple housing materials. The method starts at step 700 wherein the housing or a cover of the UE is assembled. When the housing is assembled, the actuator configuration located on the inside of, for example, the rear housing is pressed against or positioned to be proximate to the actuator sensor located on the inside of the front housing or on a PCB within the front housing. At step 702 the radio unit or circuitry of the UE is powered on for a first time. At step 704 the processor turns on an electronic switch or switches thereby powering the actuator sensor. The processor then checks the actuator sensor state or states and read the state as an actuator sensor signal or a material type signal.

At step 706, after the material type or actuator sensor signal is read by the processor, the processor may determine the particular material, from a plurality of materials, which the UE housing is composed of or the particular material on a portion of the UE housing that is proximate to an antenna contained within the UE housing. At step 708, the processor retrieves a tuning signal from the tuner state database. The tuner state database is stored within a memory device of the UE. At step 710, the processor provides the tuning signal to an antenna tuner circuit. The tuning signal is one of a plurality of predetermined tuning signals that are available in the database for each particular housing material type and frequency band combination that may be used by the UE transceiver. In some embodiments, the tuning signal is a binary signal provided to the antenna tuner circuit. In other embodiments the tuning signal is provided to a digital to analog converter, which in turn provides predetermined voltages to the tuning capacitors (or other tunable impedance devices) in the tuning circuit to tune the antenna such that the impedance between the transceiver and the antenna for the particular frequency is matched for the particular housing material that is proximate to the antenna.

At step 712, the processor may periodically check the actuator sensor state to determine if the housing portion that is proximate to the antenna has been changed with another housing portion that is composed of a different material. If it is determined that the actuator sensor state has changed, then at step 714 the method goes back to step 706. Conversely, if it is determined that the actuator sensor state has not changed, then at step 714 the method loops back to step 712 wherein at some predetermined periodic time period the actuator sensor state is rechecked.

In some embodiments, removal of the factory rear housing cover and exchanging it for a different rear housing cover may set a flag within the microprocessor that voids a UE's warranty. For example, if the original rear housing cover has an actuator configuration of a 1 1, and it is replaced with a rear housing cover that does not have any actuator configuration (i.e., 0 0), then when the processor senses the actuator sensor circuit it will read the 0 0, which will be indicative of a rear cover housing material change. If a rear cover housing material change is sensed, than a warranty void flag can be set and stored within the UE's memory such that if the phone is brought in for repair or warranty work due to a malfunction, the warranty will be invalidated or voided due to the swapping of the original rear cover with another as indicated by reading the warranty status of the warranty void flag by a service technician.

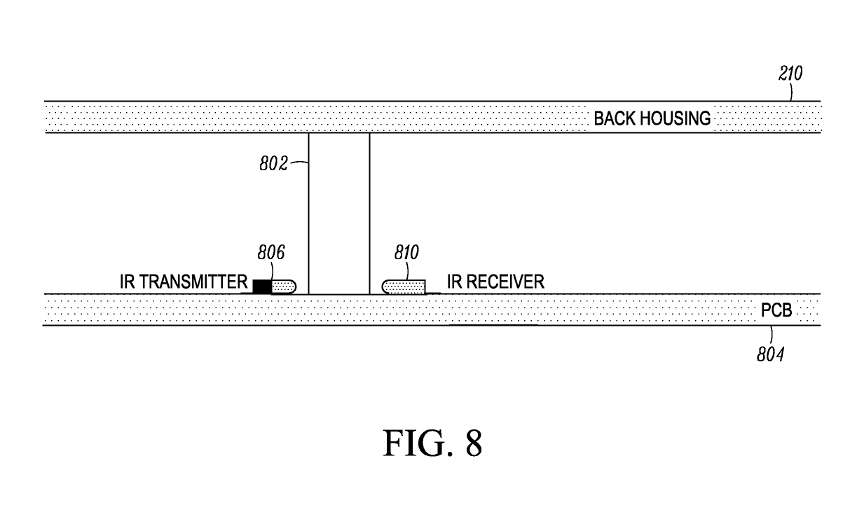

FIG. 8 depicts one of a plurality of different types of actuator configuration/actuator sensor (actuator combinations) that can be used in exemplary embodiments. Here the rear housing 210 has a post 802 as the actuator configuration or part thereof. When the rear housing 210 is assembled to the front housing portion (not specifically shown), the post 802 interferes with an infrared (IR) transmitter 806 and receiver coupling 810. If the post 802 is not present then the IR transmitter 806 and receiver coupling 810 will provide a different output. In other embodiments, the post 802 may simply press against a pad that senses the existence or nonexistence of the post. The pad may be a reflowed pad switch on a printed circuit board 804. In yet other embodiments, the post may comprise a capacitive or resistive member or feature that is sensed by an appropriate sensor inside the UE housing when the front and back portions of the UE housing are assembled. In essence, the actuator combinations provide the ability for the circuitry within the UE to determine the material composing a removable or replaceable housing portion proximate to a UE antenna such that the antenna can be tuned to operate more efficiently near the determined housing material and at the frequency band that the UE is operating.

In the foregoing specification, embodiments have been described with reference to specific examples. It will, however, be evident that various modifications and changes may be made therein without departing from the broader scope of the invention as set forth in the appended claims. For example, although the actuator configuration is described as being on the inside of the rear housing portion, instead the actuator sensors may be on the inside of the rear housing portion such that different number of sensors is provided depending on the particular material that the rear housing portion is constructed. The front housing material composition or type may also be detected by a similar means and technique.

Some of the above embodiments, as applicable, may be implemented using a variety of different processing systems. For example, the Figures and the discussion thereof describe an exemplary architecture and method which is presented merely to provide a useful reference in discussing various aspects of the disclosure. Of course, the description of the architecture and method has been simplified for purposes of discussion, and is just one of many different types of appropriate architectures and methods that may be used in accordance with the disclosure. Those skilled in the art will recognize that the boundaries between program, electronic and physical elements are merely illustrative and that alternative embodiments may merge elements or impose an alternate compositions or decompositions of functionality upon various elements. Although the preferred embodiment has been described in detail, it should be understood that various changes, substitutions and alterations can be made therein without departing from the spirit and scope of the invention as defined by the appended claims.

What is claimed is:

1. A mobile communication device comprising:
a housing, the housing comprising:
a front housing portion configured to contain an actuator sensor; and
a rear housing portion being made of a rear housing material and having an inside and an outer side, the rear housing portion further comprising an actuator configuration on the inside that is configured to be sensed by the actuator sensor when the front housing portion and the rear housing portion are combined to establish the housing; the actuator configuration adapted to be sensed by the actuator sensor so as to indicate that the rear housing material is a particular material.

2. The mobile communication device of claim 1, further comprising:
a processor connected to the actuator sensor and configured to read the actuator configuration;
an antenna;
a transceiver;
an antenna tuner, connected between the transceiver and the antenna, the antenna tuner configured to receive an indication of the actuator configuration from the processor and to use the indication of the actuator configuration to set an impedance of the antenna tuner in accordance with the particular material of the rear housing portion and a frequency band.

3. The mobile communication device of claim 1, wherein the actuator sensor comprises a plurality of switches adapted to be selectively closed by the actuator configuration.

4. The mobile communication device of claim 1, wherein the actuator configuration comprises at least one feature extending from the inside of the rear housing toward the front housing portion; and wherein the actuator sensor is configured to sense a presence or a width of each of the at least one feature.

5. The mobile communication device of claim 1, further comprising:
an antenna;
a transceiver;
an antenna tuner connected between the antenna and the transceiver;
a processor configured to read an actuator signal from the actuator sensor and obtain a tuner offset associated with the actuator signal, the processor further configured to provide the tuner offset to the antenna tuner, the tuner offset adapted for use by the antenna tuner to tune the antenna for a transceiver frequency band based on the particular material of the rear housing material.

6. The mobile communication device of claim 5, further comprising a memory, the memory storing a plurality of tuner offsets wherein each tuner offset is associated with the particular material of the rear housing material associated with actuator signal and the transmit or receive frequency band of the transceiver; wherein the processor obtains the tuner offset associated with the actuator signal from the memory.

7. The mobile communication device of claim 1, wherein the particular material is one of a plastic material, an epoxy resin material, a wood based material, a ceramic material, a Kevlar material, a metal material and a composite material.

8. The mobile communication device of claim 1, wherein the actuator configuration is a null actuator configuration that when sensed by actuator sensor indicates that the rear housing material is a default material.

9. A mobile communication device comprising:
an antenna for transmitting or receiving a frequency band;
a transceiver configured to transmit or receive the frequency band;
an antenna tuner, connected between the transceiver and the antenna, configured to tune the antenna based on a tuning signal;
a housing having an opened and a closed position, the housing comprised of a housing material that effects tuning of the antenna in the frequency band, the mobile communication device housing further comprising an actuator feature configured to indicate that the housing material is one housing material of a plurality of housing materials;
an actuator sensor within the housing and configured to sense the housing material indicated by the actuator feature when the housing is in the closed position, the actuator sensor providing a material type signal;
a processor configured to receive and use the material type signal to generate the tuning signal for the antenna tuner.

10. The mobile communication device of claim 9, wherein the plurality of housing materials comprise at least one of a plastic material, an epoxy resin material, a ceramic material, a Kevlar material, a wood based material, a metal material, and a composite material.

11. The mobile communication device of claim 9, wherein the actuator feature comprises a post configuration adapted to engage actuator sensor when the housing is in a closed position, the post configuration indicating the housing material.

12. The mobile communication device of claim 9, further comprising a memory configured to store an antenna tuner database, the processor being further configured to use the tuner database to generate the tuning signal for the antenna tuner based on the material type signal and the frequency band.

13. A method of tuning an antenna in a mobile communication device comprising a housing material being one of a plurality of housing materials, the method of tuning comprising:
powering on a transceiver in the mobile communication device;
sensing, by an actuator sensor, an actuator configuration located on an inside of a mobile communication device housing;
providing, by the actuator sensor, a material type signal;
using the material type signal to determine a material type and providing a tuning signal, the tuning signal being one of a plurality of predetermined tuning signals based on the material type and a frequency band being used by the transceiver;
tuning an antenna tuner to match an impedance between the transceiver and the antenna for the housing material and the frequency band being used by the transceiver.

14. The method of claim 13, wherein the sensing is performed once when the transceiver is powered on.

15. The method of claim 13, wherein a processor performs using the material type signal and providing the tuner signal.
